(19) United States
(12) Patent Application Publication
(10) Pub. No.: US 2022/0414430 A1
(43) Pub. Date: Dec. 29, 2022

(54) DATA SIMULATION USING A GENERATIVE ADVERSARIAL NETWORK (GAN)

(71) Applicant: International Business Machines Corporation, Armonk, NY (US)

(72) Inventors: Shuo Li, Beijing (CN); Xiaobo Wang, Beijing (CN); Sheng Yan Sun, Beijing (CN); Rui Wang, Xian (CN)

(21) Appl. No.: 17/357,243

(22) Filed: Jun. 24, 2021

(51) Int. Cl. G06N 3/04; G06N 3/08; G06F 16/28; G06F 16/2457; G06F 16/2452

(52) U.S. Cl. CPC G06N 3/0454; G06N 3/08; G06F 16/285; G06F 16/24578; G06F 16/24528

(57) ABSTRACT

A Generative Adversarial Network is used to train and/or tune a model used to analyze data in a database or data stream. The Generative Adversarial Network intermittently trains or tunes the model as the database is actively ingesting data and/or while the data stream is streaming. This intermittent refreshing of the model, performed by the Generative Adversarial Network, is sometimes described as “dynamic” or “dynamical.” Analytics type software is queried in order to perform normalization and/or model training.

### BACKGROUND

The present invention relates generally to the field of generative adversarial networks, and also to data simulation.

The Wikipedia entry for “generative adversarial networks” (as of Apr. 6, 2021) states in part as follows: “A generative adversarial network (GAN) is a class of machine learning frameworks . . . . Two neural networks contest with each other in a game (in the form of a zero-sum game, where one agent's gain is another agent's loss). Given a training set, this technique learns to generate new data with the same statistics as the training set. For example, a GAN trained on photographs can generate new photographs that look at least superficially authentic to human observers, having many realistic characteristics. Though originally proposed as a form of generative model for unsupervised learning, GANs have also proven useful for semi-supervised learning, fully supervised learning, and reinforcement learning. The core idea of a GAN is based on the ‘indirect’ training through the discriminator, which itself is also being updated dynamically. This basically means that the generator is not trained to minimize the distance to a specific image, but rather to fool the discriminator. This enables the model to learn in an unsupervised manner. Method[.] The generative network generates candidates while the discriminative network evaluates them. The contest operates in terms of data distributions. Typically, the generative network learns to map from a latent space to a data distribution of interest, while the discriminative network distinguishes candidates produced by the generator from the true data distribution. The generative network's training objective is to increase the error rate of the discriminative network (i.e., ‘fool’ the discriminator network by producing novel candidates that the discriminator thinks are not synthesized (are part of the true data distribution)). A known dataset serves as the initial training data for the discriminator. Training it involves presenting it with samples from the training dataset, until it achieves acceptable accuracy. The generator trains based on whether it succeeds in fooling the discriminator.” (footnote(s) omitted)

The Wikipedia entry for “neural network” (as of Apr. 7, 2021) states as follows: “A neural network is a network or circuit of neurons, or in a modern sense, an artificial neural network, composed of artificial neurons or nodes. Thus, a neural network is . . . an artificial neural network, for solving artificial intelligence (AI) problems. The connections of the biological neuron are modeled as weights. A positive weight reflects an excitatory connection, while negative values mean inhibitory connections. All inputs are modified by a weight and summed. This activity is referred to as a linear combination. Finally, an activation function controls the amplitude of the output. For example, an acceptable range of output is usually between 0 and 1, or it could be −1 and 1. These artificial networks may be used for predictive modeling, adaptive control and applications where they can be trained via a dataset. Self-learning resulting from experience can occur within networks, which can derive conclusions from a complex and seemingly unrelated set of information . . . . Artificial intelligence, cognitive modeling, and neural networks are information processing paradigms inspired by the way biological neural systems process data. Artificial intelligence and cognitive modeling try to simulate some properties of biological neural networks. In the artificial intelligence field, artificial neural networks have been applied successfully to speech recognition, image analysis and adaptive control, in order to construct software agents (in computer and video games) or autonomous robots.” (footnote(s) omitted)

Data simulation obtains a small amount of data from real data, removes production features, obtains data distribution features and statistics from a production database, and uses a method to generate data having the same data distribution features as those from the production database. As an example, flight simulation gives the same environment to the pilot to test his/her reaction under different situations. As another example, a Monte Carlo sampling computer program uses random sampling to simulate and learn. As a further example, a customer has a lot of data in a production database. When the customer has a database performance issue, the customer may need a database enterprise provider to perform a database tuning service. However, the customer needs to keep his/her production data confidential due to laws and regulations, so there is a need to provide desensitization or data simulation.

### SUMMARY

According to an aspect of the present invention, there is a method, computer program product and/or system that performs the following operations (not necessarily in the following order): (i) receiving a set of raw data; (ii) pre-processing the raw data to obtain pre-processed data; (iii) analyzing pre-processed raw data to obtain a plurality of extra pattern(s), with the extra patterns being programmed and/or structured to enrich the pre-processed raw data in the event that a whole data picture is incomplete; (iv) creating discriminator data for use by a discriminator component of a generative adversarial network (GAN), with the discriminator data including sample data and database (DB) statistics; (v) building a generative model, based on DB model activities, for use by the GAN; (vi) performing grow database (DB) activities to grow DB activities to obtain a plurality of grown DB activities; and (vii) performing a reward operation based, at least in part, on the grown DB activities.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system;

FIG. 5 is a block diagram helpful in understanding various embodiments of the present invention; and

FIG. 6 is another block diagram helpful in understanding various embodiments of the present invention.

### DETAILED DESCRIPTION

Under currently conventional technology: (i) a Generative Adversarial Network is used to train and/or tune a model used to analyze data in a database or data stream; and (ii) the model is completely trained and completely tuned before the model is used to analyze the database or data stream. In some embodiments of the present invention, and unlike the prior art, the Generative Adversarial Network intermittently trains or tunes the model as the database is actively ingesting data and/or while the data stream is streaming. This intermittent refreshing of the model, performed by the Generative Adversarial Network, is sometimes described as “dynamic” or “dynamical.” In some embodiments, analytics type software is queried in order to perform normalization and/or model training. This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

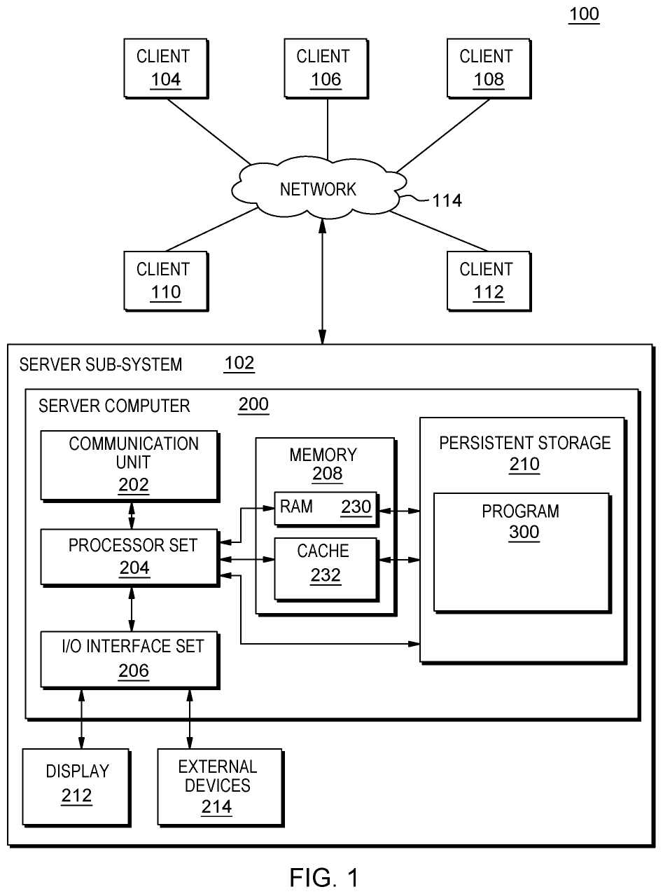

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

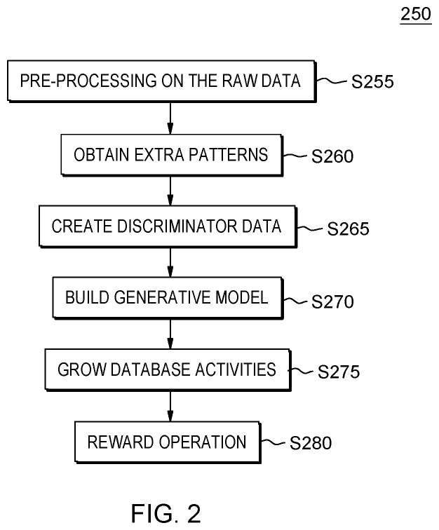

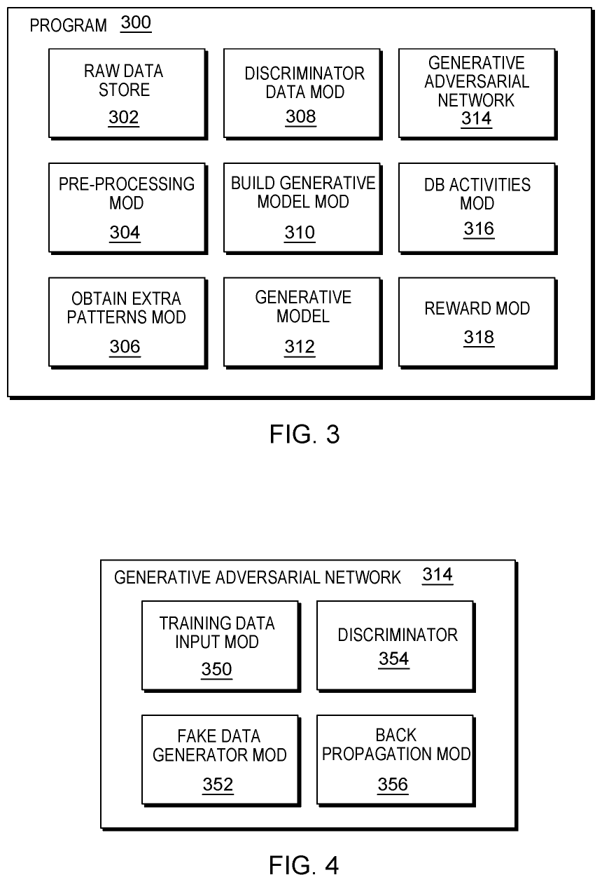

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

A method for performing data simulation using a generative adversarial network (GAN) will now be explained in the following paragraphs.

Processing begins at clean data operation S255, where pre-processing module (“mod”) 304 performs pre-processing on the raw data of raw data store 302. The raw data is first cleaned. In this part of operation S255, the raw data is cleaned by removing production database business features that include business confidential information, potential security issues, or potential audit issues. For example, in a real production database, assume there are 100,000 rows (a1, b1, c1), and 20,000 rows (a1, b2, c2). The clean operation may need to update them as 100,000 rows (A1, B1, C1), and 20,000 rows (A1, B2, C2). The columns' values maybe be totally or mostly different, but the data distribution needs to be the same as the original data. The basic data should come from the data resource, for example, the product database. After the data has been cleaned, it is “concealed” as the next part of operation S265. In this operation, information is removed, as appropriate and necessary, for business confidential, security, or other audit reasons. If the information is not concealed or cleaned, it may not pass an audit process. The customer, for business confidential reasons, can't pass the original data to database suppliers or other partners, but needs to perform or use other tests based on the database. Thus, this embodiment provides for data simulation to make a new database that is the same as the customer's product database, but without sensitive data.

Processing proceeds to obtain extra patterns operation S260, where obtain extra patterns mod 306 performs various parts of operation S260 as will be discussed in this paragraph. The cleaned and concealed data is analyzed to obtain a set of extra patterns. In this operation, the cleaned and concealed data is removed. The whole data picture may be incomplete, for example some join or constraint information may be lost. Thus, patterns are created to enrich the data.

Processing proceeds to create discriminator data operation S265, which is performed by the machine logic of discriminator data mod 308. Discriminator data with sample data and DB (database) statistics is created by the following sub-operations of operation S265: (i) input clean and concealed sample data from product database, DB statistics, set corresponding frequency weight and total effective samples; (ii) calculate categorical distribution for a multinomial distribution; (iii) categorically include a database statistics table, column, multi-column, partition table, and feature factors including Cardinality, Low2key, High2key, Frequency, Histogram, etc.; (iv) perform calculation for goodness of fit measure; and (v) grow discriminant data from clean and concealed sample data with a DB statistic distribution model.

Processing proceeds to build generative model operation S270, where build generative model mod 310 builds generative model 312 for use by generative adversarial network (GAN) 314. As shown in FIG. 4, GAN 314 includes the following: training data input mod 350; fake data generator mod 352; discriminator 354; and backpropagation mod 356. Mod 310 builds a self-adaption generative model based on model database (DB) activities by performing the following sub-operations of operation S270: (i) generative model generates multiple attempts to avoid the local optimal solution from DB statistics; (ii) discriminative model evaluates the global optimal solution from DB activities and a database statistic refresh; (iii) grow data with DB statistics and distribution; (iv) the confidence of new data supports the DB activities result where sample data is used to generate new data, that is, the new data needs to make all database activities work well to obtain the expected result; and (v) terminate when the confidence level is considered to be sufficiently large, that is, the design engineer can set an experience value or run double checks to set the confidence level threshold value.

Processing proceeds to grow operation S275, where database (DB) activities mod 316 grows the DB activities in a manner using the confidence level. In this operation, the database may have different kinds of activities. For example, at the very beginning, provide query 1-10 for initial data generation. In real world usage, this may provide different kinds of database activates DCL (data control language), DDL (data definition language), DML (data manipulation language), or other data related maintain processes (for example, a statistical collection and query rewrite).

Processing proceeds to reward operation S280, where reward mod 318 performs the following sub-operations of operation S280: (i) each query feature normalizes as vectors for calculating similarity to generated data (that is, normalizing can try to make query statement evaluation not involving predicate influence). For example, select * from T1 where id=1, select * from T1 where id=2, select * from T1 where id=500 may normalize as select * from T1 where id=? after query normalizing. This will make it easy to calculate all of the complex query statements. In any particular statement, the result count or result distribution can be obtained with statement structure and database statistics. If normalization is not performed, it should not affect the computation itself, but it may increase the complexity. Thus, this operation is about performance improvement; (ii) query analytics to normalize the data; (iii) perform model training of the data; (iv) use generated data to purge the data (that is, purge and refresh means after data generation, a new data quality validation is performed. This may include the need to purge some exception data (for example, may increase with the model but may fail with a new, similar query check); and (v) refresh the data with query rank weighting. More specifically on the model training sub-operation (iii), one, or more, of the following features or operations may be used: (a) Predicate Analyzer; (b) Foreign Key; and (c) SQL (structured query language) Mutate. Item (c) on the foregoing list, SQL mutate, includes: (1) SQL Parse (SQL is parsed as a parse tree); (2) Pattern Sort: sort the SQL by a different pattern; (3) Mutation Pattern (Simple Mutation Pattern, Subquery, Having clause); and (4) Generate SQLs (Extract Join Predicates, Reconstruct SQL, Sample Result Set, Mutate SQL).

### III. Further Comments and/or Embodiments

Some embodiments of the present invention recognize the following facts, potential problems and/or potential areas for improvement with respect to the current state of the art: (i) database quality is very important where the main problem is that during functional test, testers find it difficult to create proper data to make a complex query to return certain data records; (ii) focuses on the process to generate proper data based on the given query and ensures that the query has qualified records; (iii) currently, the common method is to mask the sensitive information for data, but most of customers would not like to do so for policy reasons; and/or (iv) could be dynamical adjusted based on the changes of the user data.

Some embodiments of the present invention may include one, or more, of the following operations, features, characteristics and/or advantages: (i) provides a method to dynamically adjust simulation data based on real database activities which includes two (2) models: (a) a self-adaption reinforcement model, and (b) a generative model for data growth with sample data adversarial; (ii) includes data statistics and distribution status; (iii) includes real database activities which are rank weighted; (iv) includes a dynamic discriminator model trained from sample data; (v) includes DB (database) statistics to build discriminant data; (vi) supports database manage system data simulation with real database activities; and/or (vii) the model can be updated using real data statistic refresh.

Some embodiments of the present invention may include one, or more, of the following operations, features, characteristics and/or advantages: (i) introduces a method for data simulation based on generative adversarial networks; (ii) the generative network generates candidates, while the discriminative network evaluates them; (iii) operates in terms of data distributions; (iv) the generative network learns to map from a latent space to a data distribution of interest, while the discriminative network distinguishes candidates produced by the generator from true data distribution; (v) the generative network's training objective is to increase the error rate of the discriminative network; (vi) a known dataset serves as the initial training data for the discriminator; (vii) training the generative network involves presenting it with samples from the training dataset until it achieves acceptable accuracy; (viii) the generator trains based on whether it succeeds in fooling the discriminator; and/or (ix) the generator is seeded with randomized input that is sampled from a predefined latent space.

Some embodiments of the present invention may include one, or more, of the following operations, features, characteristics and/or advantages: (i) candidates synthesized by the generator are evaluated by the discriminator; (ii) backpropagation is applied in both networks so that the generator produces better images, while the discriminator becomes more skilled at flagging synthetic images; (iii) the generator is typically a deconvolutional neural network, and the discriminator is a convolutional neural network; and/or (iv) monitors changes of the user data.

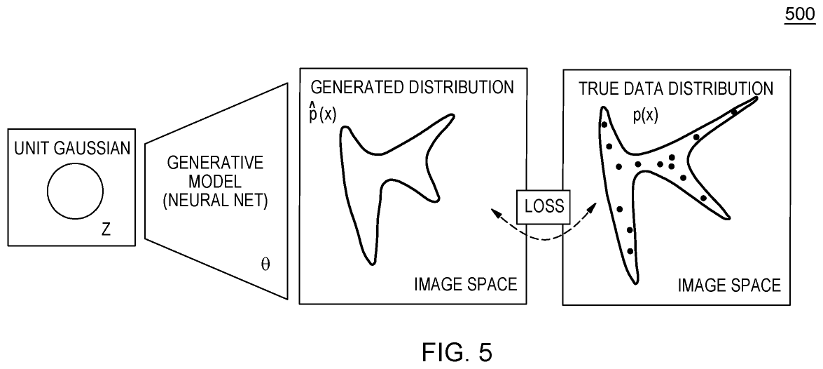

As shown in FIG. 5, diagram 500 shows: (i) a data simulation based on the new changes of the user data; (ii) a gaussian unit z is sampled from a gaussian distribution from generative model (neural net) to obtain X; and (iii) X is satisfied with generated distribution which is made as close to a true data distribution as possible (realistically, it is understood by those of skill in the art that the generated distribution can't be the same as the true data distribution—the difference is shown by the block labelled LOSS in diagram 500.

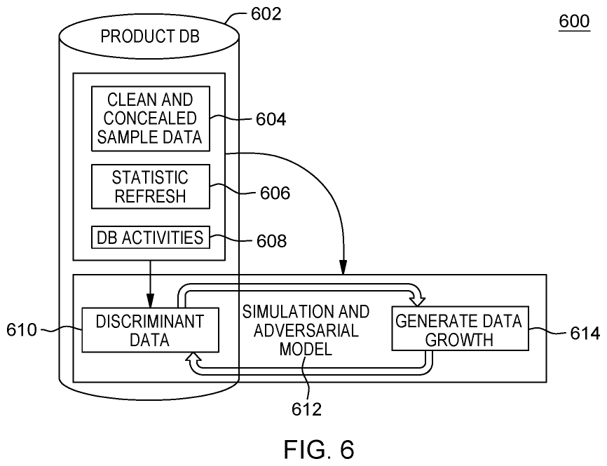

As shown in FIG. 6, diagram 600 includes: product database storage 602; clean and concealed sample data block 604; statistic refresh block 606; DB activities block 608; discriminant data block 610; simulation and adversarial model block 612; and generate data growth block 614.

Some embodiments of the present invention may include one, or more, of the following operations, features, characteristics and/or advantages: (i) generative adversarial networks (GANs) are an approach to generative modeling using deep learning methods, such as convolutional neural networks; (ii) generative modeling is an unsupervised learning task in machine learning that involves automatically discovering and learning the regularities or patterns in input data in such a way that the model can be used to generate or output new examples that plausibly could have been drawn from the original dataset; (iii) GANs are a clever way of training a generative model by framing the problem as a supervised learning problem with two (2) sub-models: (a) the generator model that can be trained to generate new examples, and (b) the discriminator model that tries to classify examples as either real (from the domain) or fake (generated); (iv) the two (2) models are trained together in a zero-sum game, adversarial, until the discriminator model is fooled about half the time, meaning the generator model is generating plausible examples; (v) GANs are an exciting and rapidly changing field, delivering on the promise of generative models in their ability to generate realistic examples across a range of problem domains, most notably in image-to-image translation tasks (for example, such as translating photos of summer to winter or day to night, and in generating photorealistic photos of objects, scenes, and people that even humans cannot tell are fake); and/or (vi) feature changes need to be monitored in the database, and with this method, has the ability to make the data simulation based on user changes.

Some embodiments of the present invention may include one, or more, of the following operations, features, characteristics and/or advantages: (i) provides a new method to dynamical adjust simulation data based on real database activities; and (ii) the method is divided into two models: (a) a self-adaption reinforcement and generative model for data growth with sample data adversarial (includes data statistics and distribution status and real database activities which are rank weighted), and (b) a dynamic discriminator model trained from sample data and DB statistics to build discriminant data.

Some embodiments of the present invention may include one, or more, of the following operations, features, characteristics and/or advantages: (i) can automatically update generated data with small pieces of clean and concealed product sample data; (ii) is considered high performance compared to existing methods; (iii) data statistics are the same as real product data; (iv) reflects real data distribution; (v) is easy to test; (vi) real database activities can make data more targeted to business needs; (vii) purge and refresh data, with query rank weighting, can create generated data having high values per size; and/or (viii) each data node can widely be used on cloud environments to support different business needs.

Some embodiments of the present invention may include one, or more, of the following operations, features, characteristics and/or advantages pertaining to clean and concealed sample data: (i) includes predefined business related input columns; (ii) can build an external model with NLP (neuro-linguistic programming) to identify correlation sensitive data columns; (iii) information columns, which will not impact the database query result, can be removed; (iv) information columns are involved in query execution; and/or (v) information columns can conceal, with a predefined pattern or by building an external model, to make the data intelligent and not easy to track.

Some embodiments of the present invention may include one, or more, of the following operations, features, characteristics and/or advantages pertaining to obtaining database statistics and query activity samples: (i) in the beginning of the process, initially obtain the two (2) kinds of input values; (ii) continue collecting and enhancing to perform model training and testing; and/or (iii) query activities can perform normalization to reduce the performance effort.

Some embodiments of the present invention may include one, or more, of the following operations, features, characteristics and/or advantages pertaining to create discriminator data with sample data and DB statistics: (i) includes input having clean and concealed sample data from the product database; (ii) includes DB statistics; (iii) can set the corresponding frequency weight and total effective sample; (iv) calculates categorical distribution for the multinomial distribution; (v) categories include a database statistics table, column, multi-column, partition table, and feature factors including cardinality, low2key, high2key, frequency, histogram, etc.; (vi) performs a calculation for goodness of fit measure; and/or (vii) grows discriminant data from clean and concealed sample data using a DB statistic distribution model.

Some embodiments of the present invention may include one, or more, of the following operations, features, characteristics and/or advantages pertaining to building a self-adaption based model using a DB activities generative model: (i) the generative model uses multiple attempts to avoid the local optimal solution from DB statistics; (ii) the discriminative model evaluates the global optimal solution using DB activities and database statistical refresh; (iii) grows the data with DB statistics and distribution; (iv) the confidence of new data supports the DB activities result; and/or (v) performs termination with high confidence, that is, is deemed good enough.

Some embodiments of the present invention may include one, or more, of the following operations, features, characteristics and/or advantages pertaining to growing and rewarding, with confidence, DB activities where: (i) each query feature normalizes as vectors for calculating the similarity to generated data; (ii) query analytics are used to normalize model training including: (a) a Predicate Analyzer, (b) a Foreign Key, and/or (c) SQL (structured query language) Mutate which includes: (1) a SQL parse, that is, SQL is parsed as parse tree, (2) pattern sort, that is, sorting the SQL using a different pattern, (3) a mutation pattern which includes: a simple mutation pattern, a subquery, and a having clause, and/or (4) generating SQLs which include operations to: extract join predicates, reconstruct the SQL, generate a sample result set, and mutate the SQL; and/or (iii) using the generated data, purge and refresh the data with query rank weighting.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
receiving a set of raw data;
pre-processing the raw data to obtain pre-processed data;
analyzing pre-processed raw data to obtain a plurality of extra pattern(s), with the extra patterns being programmed and/or structured to enrich the pre-processed raw data in the event that a whole data picture is incomplete;
creating discriminator data for use by a discriminator component of a generative adversarial network (GAN), with the discriminator data including sample data and database (DB) statistics;
building a generative model, based on DB model activities, for use by the GAN;
performing grow database (DB) activities to grow DB activities to obtain a plurality of grown DB activities; and
performing a reward operation based, at least in part, on the grown DB activities.

2. The CIM of claim 1 wherein the pre-processing includes:
cleaning the raw data to remove from the pre-processed data business features that include sensitive information.

3. The CIM of claim 2 wherein the pre-processing further includes:
removing from the pre-processed data information for confidentiality, security, and/or audit reasons.

4. The CIM of claim 1 further comprising:
performing, by the GAN, a data simulation.

5. The CIM of claim 1 further comprising:
enriching the pre-processed data to replace join and/or constraint information that has been lost.

6. The CIM of claim 1 wherein the creation of the discriminator data includes the following sub-operations:
inputting clean and concealed sample data from product database, DB statistics, set corresponding frequency weight and total effective samples;
calculating categorical distribution for a multinomial distribution;
categorically including a database statistics table, column, multi-column, partition table, and feature factors including Cardinality, Low2key, High2key, Frequency, Histogram;
performing calculation for goodness of fit measure; and
growing discriminant data from clean and concealed sample data with a DB statistic distribution model.

7. The CIM of claim 1 wherein the building of the generative model includes the following sub-operations:
generative model generates multiple attempts to avoid the local optimal solution from DB statistics;
discriminative model evaluates the global optimal solution from DB activities and a database statistic refresh;
grow data with DB statistics and distribution;
the confidence of new data supports the DB activities result where sample data is used to generate new data, so that new data makes all database activities work well to obtain an expected result; and
terminate when a confidence level is considered to be sufficiently large, that is, the design engineer can set an experience value or run double checks to set the confidence level threshold value.

8. The CIM of claim 1 wherein the grown database activities include at least one of the following: DCL (data control language), DDL (data definition language), DML (data manipulation language), a statistical collection, and/or a query rewrite.

9. The CIM of claim 1 wherein the performance of the reward operation includes the following sub-operations:
each query feature normalizes as vectors for calculating similarity to generated data;
calculating a plurality of complex query statements;
query analytics to normalize the data;
model training of the data;
use generated data to purge the data; and
refresh the data with query rank weighting.

10. A computer program product (CPP) comprising:
a set of storage device(s); and
computer code stored collectively in the set of storage device(s), with the computer code including data and instructions to cause a processor(s) set to perform at least the following operations:
receiving a set of raw data,
pre-processing the raw data to obtain pre-processed data,
analyzing pre-processed raw data to obtain a plurality of extra pattern(s), with the extra patterns being programmed and/or structured to enrich the pre-processed raw data in the event that a whole data picture is incomplete,
creating discriminator data for use by a discriminator component of a generative adversarial network (GAN), with the discriminator data including sample data and database (DB) statistics,
building a generative model, based on DB model activities, for use by the GAN;
performing grow database (DB) activities to grow DB activities to obtain a plurality of grown DB activities, and
performing a reward operation based, at least in part, on the grown DB activities.

11. The CPP of claim 10 wherein the pre-processing includes:
cleaning the raw data to remove from the pre-processed data business features that include sensitive information.

12. The CPP of claim 11 wherein the pre-processing further includes:
removing from the pre-processed data information for confidentiality, security, and/or audit reasons.

13. The CPP of claim 10 wherein the computer code further includes instructions for causing the processor(s) set to perform the following operation(s):
performing, by the GAN, a data simulation.

14. The CPP of claim 10 wherein the computer code further includes instructions for causing the processor(s) set to perform the following operation(s):
enriching the pre-processed data to replace join and/or constraint information that has been lost.

15. The CPP of claim 10 wherein the creation of the discriminator data includes the following sub-operations:
inputting clean and concealed sample data from product database, DB statistics, set corresponding frequency weight and total effective samples;
calculating categorical distribution for a multinomial distribution;
categorically including a database statistics table, column, multi-column, partition table, and feature factors including Cardinality, Low2key, High2key, Frequency, Histogram;
performing calculation for goodness of fit measure; and
growing discriminant data from clean and concealed sample data with a DB statistic distribution model.

16. The CPP of claim 10 wherein the building of the generative model includes the following sub-operations:
generative model generates multiple attempts to avoid the local optimal solution from DB statistics;
discriminative model evaluates the global optimal solution from DB activities and a database statistic refresh;
grow data with DB statistics and distribution;
the confidence of new data supports the DB activities result where sample data is used to generate new data, so that new data makes all database activities work well to obtain an expected result; and
terminate when a confidence level is considered to be sufficiently large, that is, the design engineer can set an experience value or run double checks to set the confidence level threshold value.

17. The CPP of claim 10 wherein the grown database activities include at least one of the following: DCL (data control language), DDL (data definition language), DML (data manipulation language), a statistical collection, and/or a query rewrite.

18. The CPP of claim 10 wherein the performance of the reward operation includes the following sub-operations:
each query feature normalizes as vectors for calculating similarity to generated data;
calculating a plurality of complex query statements;
query analytics to normalize the data;
model training of the data;
use generated data to purge the data; and
refresh the data with query rank weighting.

19. A computer system (CS) comprising:
a processor(s) set;
a set of storage device(s); and
computer code stored collectively in the set of storage device(s), with the computer code including data and instructions to cause the processor(s) set to perform at least the following operations:
receiving a set of raw data,
pre-processing the raw data to obtain pre-processed data,
analyzing pre-processed raw data to obtain a plurality of extra pattern(s), with the extra patterns being programmed and/or structured to enrich the pre-processed raw data in the event that a whole data picture is incomplete,
creating discriminator data for use by a discriminator component of a generative adversarial network (GAN), with the discriminator data including sample data and database (DB) statistics,
building a generative model, based on DB model activities, for use by the GAN;
performing grow database (DB) activities to grow DB activities to obtain a plurality of grown DB activities, and
performing a reward operation based, at least in part, on the grown DB activities.

20. The CS of claim 19 wherein the pre-processing includes:
cleaning the raw data to remove from the pre-processed data business features that include sensitive information.
